(19) United States
(12) Patent Application Publication
(10) Pub. No.: US 2010/0195506 A1
(43) Pub. Date: Aug. 5, 2010

(54) System and Method to Identify a Predicted Oscillatory Behavior of a Router

(75) Inventors: Aman Shaikh, Summit, NJ (US); Matthew Roughan, Woodforde (AU); Nigel Bean, Athelstone (AU); Ashley Flavel, Northgate (AU)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T INTELLECTUAL PROPERTY I, L.P., Reno, NV (US)

(21) Appl. No.: 12/362,526

(22) Filed: Jan. 30, 2009

(51) Int. Cl. H04L 12/26

(52) U.S. Cl. 370/242

(57) ABSTRACT

A computer-readable storage medium includes operational instructions, that when executed by a processor, cause the processor to receive network configuration data representing a network having a plurality of routers and to identify at least one of the plurality of routers as having a predicted oscillatory behavior based at least partially on the network configuration data.

### FIELD OF THE DISCLOSURE

The present disclosure is generally related to identifying a predicted oscillatory behavior of a router.

### BACKGROUND

Each router in a network has a routing table that includes routes used by the router to send a packet to its destination. The routes specify a next-hop router to which the packet is sent. For example, when a route at router A specifies router B as the next-hop to destination D and router A receives a packet destined to destination D, router A sends the packet to router B. Router B then consults its own routing table to determine the next-hop router. In this way, the packet ultimately reaches its destination.

When using routing protocols, such as Border Gateway Protocol (BGP), router A may receive a route from each neighboring router, such as router B. Router A receives routes from neighboring routers and uses a BGP route selection process to determine a best route to use among the received routes. In the above example, router A selected router B as the next-hop router in its routing table because router A selected a route received from router B. Occasionally, one or more intermediate routers may act as proxies for other routers. For example, a router E may inform the router A that the next-hop is router B. Router A then sends router A's preferred routes to all of router A's neighboring routers to enable the neighboring routers to select their own preferred routes.

A network has a stable configuration when all the routers in the network converge to a state in which each router has selected its most preferred route from the set of routes it receives from other routers, each router does not change its preferred routes, and a packet routed to any destination D reaches D by traversing a path based on the routes selected by the routers from any source S in the network.

One problem with large networks is router oscillation. Router oscillation occurs when a set of routers continually change their most preferred route when the network is otherwise stable. For example, when router A is involved in an oscillation, router A continually changes its most preferred route. Each time router A selects a new route, router A sends the new route to all neighboring routers which may cause some of the neighboring routers to change their most preferred route. The neighboring routers also send their preferred routes to router A. Eventually, router A changes its most preferred route and the cycle continues. Router oscillation consumes resources on routers involved in the oscillation and the forwarding of packets via the network suffers because the routers involved in the oscillation do not stabilize.

Networks can be designed to avoid routing oscillation, but most approaches unnecessarily reduce configuration flexibility. In addition, networks designed using these approaches may be initially stable, but seemingly minor configuration changes can lead to router oscillation and instability. In a network with hundreds of routers, verifying the stability of the network may be computationally prohibitive because verifying the stability of a particular network configuration is computationally nondeterministic polynomial-time hard (NP hard).

### BRIEF DESCRIPTION OF THE DRAWINGS

FIG. 1 is a block diagram of a first particular embodiment of a system to identify a predicted oscillatory behavior;

FIG. 2A is a block diagram of a first particular embodiment of a co-reliance group;

FIG. 2B is a block diagram of a second particular embodiment of a co-reliance group;

FIG. 3 is a block diagram of a third particular embodiment of a co-reliance group;

FIG. 4 is a block diagram of a fourth particular embodiment of a co-reliance group;

FIG. 5 is an illustrative embodiment of a table of predicted oscillatory behavior;

FIG. 6A is a block diagram of a first particular embodiment of a reliance graph;

FIG. 6B is a block diagram of a second particular embodiment of a reliance graph;

FIG. 6C is a block diagram of a third particular embodiment of a reliance graph;

FIG. 7 is a block diagram of a first particular embodiment of a state machine;

FIG. 8 is a block diagram of a second particular embodiment of a state machine;

FIG. 9 is a block diagram of a third particular embodiment of a state machine;

FIG. 10 is a block diagram of a system having a route selection process to prevent oscillatory behavior;

FIG. 11 is a block diagram of a third particular embodiment of a system to identify a predicted oscillatory behavior;

FIG. 12 is a block diagram of a fourth particular embodiment of a system to identify a predicted oscillatory behavior;

FIG. 13 is a flow diagram of a first particular embodiment of a method to identify a predicted oscillatory behavior;

FIG. 14 is a flow diagram of a first particular embodiment of a method to identify a predicted oscillatory behavior; and

FIG. 15 is a block diagram of an illustrative embodiment of a general computer system.

### DETAILED DESCRIPTION

In a particular embodiment, a computer-readable storage medium includes operational instructions, that when executed by a processor, cause the processor to receive network configuration data representing a network having a plurality of routers and to identify at least one of the plurality of routers as having a predicted oscillatory behavior based at least partially on the network configuration data.

In another particular embodiment, a method includes receiving configuration data of a network having a plurality of routers. The method includes creating a reliance graph based on the configuration data. The reliance graph identifies when a first router is reliant on a second router to learn a route. The method also includes partitioning the reliance graph into groups. The method also includes pruning groups having non-oscillatory properties from the reliance graph. The method also includes identifying an oscillatory property of each group of the pruned reliance graph. The method also includes generating a report including the identified oscillatory properties of each group.

In another particular embodiment, a system includes an interface operable to receive data representing routers of a network. The system includes a modeling module operable to create a model representing the network based on the data. The model includes a plurality of nodes corresponding to the routers of the network. The system also includes an analysis module operable to group each of the nodes based on at least one characteristic of the associated router and to identify an oscillatory property of each group of nodes of the model. The system also includes a report generator operable to generate a report identifying the oscillatory property of each group of nodes of the model.

In another particular embodiment, an autonomous system includes a modified network including a plurality of routers. Each router has a non-oscillatory state. The modified network is associated with a modified network representation. The modified network representation includes an initial network representation including at least one router having a predicted oscillatory behavior and a modification to eliminate the predicted oscillatory behavior.

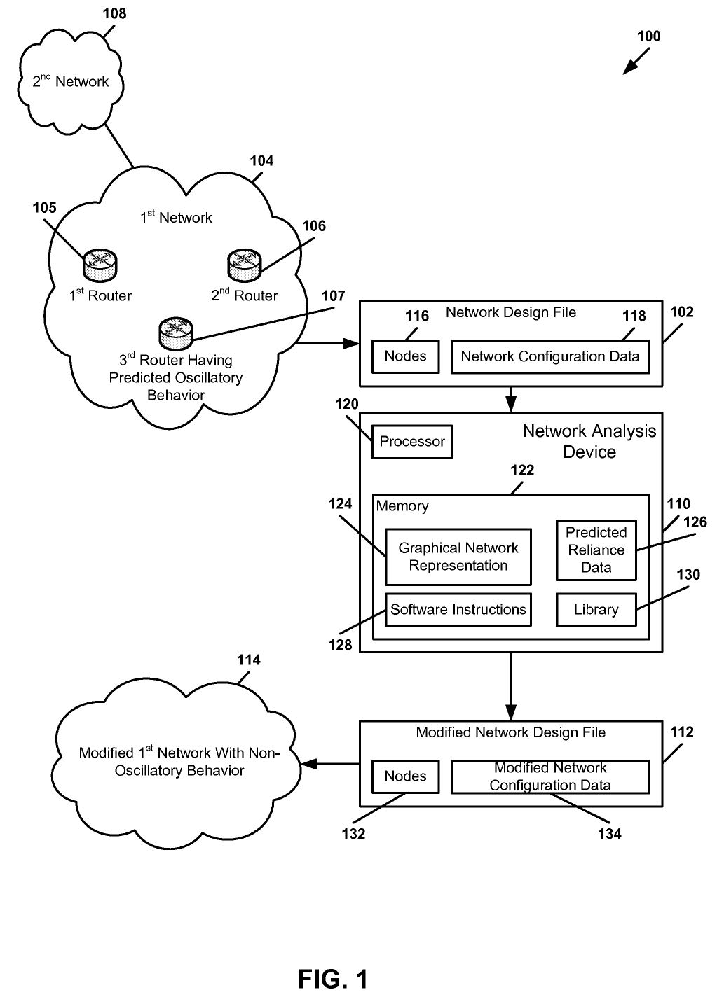

Referring to FIG. 1, a block diagram of a first particular embodiment of a system to identify a predicted oscillatory behavior is depicted and generally designated 100. The system 100 includes a network design file 102, a first network 104, a network analysis device 110, a modified network design file 112 and a modified first network with non-oscillatory behavior 114. The first network 104 is coupled to a second network 108.

The first network 104 includes a first router 105, a second router 106, and a third router having predicted oscillatory behavior 107. A router is predicted to have an oscillatory behavior when the router is predicted to repeatedly select a route previously discarded by the router. The routers 105-107 are operable to route data packets within the first network 104 and between the first network 104 and the second network 108. In a particular embodiment, the routers 105-107 are configured to use at least one of an internal Border Gateway Protocol (iBGP) and an Interior Gateway Protocol (IGP).

The network design file 102 includes nodes 116 and network configuration data 118 associated with the first network 104. For example, the network design file 102 may include data describing the various components, such as the routers 105-107 of the first network 104, how the components interact with each other, routing distances, protocols used by the components, other networking related data, or any combination thereof.

The network analysis device 110 includes a processor 120 and a memory 122. The memory 122 includes a graphical network representation 124, predicted reliance data 126, software instructions 128, and a library 130. The network analysis device 110 is configured to receive the network design file 102 corresponding to the first network 104 and to output the modified network design file 112. The modified network design file 112 includes nodes 132 and modified network configuration data 134. The modified network design file 112 may be used to create the modified first network with non-oscillatory behavior 114.

In operation, the network analysis device 110 receives the network configuration data 118 associated with the first network 104 having the routers 105-107. The network analysis device 110 identifies at least one of the routers 105-107, i.e. the third router 107, as having a predicted oscillatory behavior based at least partially on the network configuration data 118.

The network analysis device 110 identifies the predicted reliance data 126 for each of the routers 105-107. The routers 105-107 may each learn a route from a neighboring router. For example, the third router 107 may learn a route from the first router 105 and from the second router 106. The routers 105-107 may each use route selection rules to select a best route from the learned routes. Each of the routers 105-107 propagates the best route of that router to other routers. For example, when the third router 107 learns a first route (not shown) from the first router 105 and a second route (not shown) from the second router 106, the third router 107 may select the first route as the best route and propagate the first route to the routers 105-106.

A router is predicted to be reliant on a neighboring router when the router is capable of learning a best route from the neighboring router. The network analysis device 110 creates the graphical network representation 124 that includes a reliance graph representing the first network 104 based at least partially on the predicted reliance data 126. The reliance graph has nodes representing the routers 105-107. The network analysis device 110 prunes, from the reliance graph, the nodes of the graphical network representation 124 that do not propagate routes to other routers. The network analysis device 110 partitions the reliance graph into co-reliance groups where each router of the co-reliance group is predicted to be capable of learning a route of another member of the co-reliance group. The network analysis device 110 identifies the predicted group of behavior of each co-reliance group as good (stable state), asymptotically good (eventually enters a stable state), naughty (has both a stable state and an oscillation state from which it cannot exit), or bad (always oscillates). Thus, the network analysis device 110 analyzes the network design file 102 to determine whether the configuration of the first network 104 is stable. By identifying the third router having a predicted oscillatory behavior 107, the network analysis device 110 determines that the first network 104 is not stable. The network analysis device 110 creates the modified network design file 112 to enable the creation of the modified first network with non-oscillatory behavior 114. Each router of the modified network configuration data 134 is predicted to have a non-oscillatory behavior.

The BGP is a protocol that may be used to exchange routing-related information between autonomous systems (AS). An autonomous system is a collection of connected internet protocol (IP) routing prefixes that present a common, clearly defined routing policy to the Internet. A routing prefix is a collection of IP addresses having a common prefix among the IP addresses. In a particular embodiment, the first network 104 is a first AS and the second network 108 is a second AS. Each of the routers 105-107 of the first network 104 learn of available routes from neighboring routers and independently select their best route by considering attributes associated with the routes. Only the selected route is propagated to neighboring routers.

Internal BGP (iBGP) is used to propagate externally learned routes between routers inside a single AS. A router that learns a route directly from a neighboring AS is referred to as an egress router. For example, when the first network 104 is a first AS, the second network 108 is a second AS, and the first router 105 learns a route from the second network 108, the first router 105 may be referred to as an egress router.

iBGP may use a hierarchical configuration known as route-reflection, having two types of routers, a parent router, called a route-reflector, and a child router, called a client. Although route-reflection can have multiple hierarchical levels, for the sake of clarity only a two-level hierarchy is discussed herein. The two-level hierarchy may be extended to more complex hierarchies. In the two-level hierarchy, each router is either a route-reflector (RR) router or a client router of an RR. A client router propagates external routes, i.e. routes learned directly from a neighboring AS to their parent RRs. An RR selects the best route and ‘reflects’ routes based on the source of the route. When the source of the route is another RR, the RR reflects the route to all clients. When the source of the route is a client, the RR reflects the route to all iBGP neighbors. Each router determines which of the available routes are selected based on a route selection process that includes selecting the route with the lowest interior gateway protocol (IGP) distance to the egress router. When multiple routes have equal IGP distances, the router uses a tie-break rule that selects the route associated with the lowest router identifier. Each router has an associated router identifier that is used to identify the router from which a packet originated. In a particular embodiment, the router identifier may be an internet protocol (IP) address of the router.

An iBGP configuration C may be algebraically expressed as a pair, C=(GP, GS), where GP is the physical graph and GS is the signaling graph. The physical graph is based on the physical connections between components of a network. The signaling graph is based on the signaling relationships between the components of the network. For example, the graphical network representation 124 may represent a physical topology of the first network 104 and may be defined by the quartet Gp=(V, B, Ep, d). Each node u ∈ V represents a router in a network V, such as the first network 104. B ⊂ V is the set of border routers with physical connectivity to external networks, such as the second network 108. The set of edges between routers is Ep, and d(e) is the interior gateway protocol (IGP) distance of the edge e=(u, v) ∈ Ep. A path P is a sequence of edges P=e₁e₂ . . . eₙ. The length of P is the sum of the distances d(e) for all edges e of P, and the IGP is used to compute the shortest paths.

The graphical network representation 124 includes a directed signaling graph GS=(V, AS) that represents the propagation of BGP routes between routers within V. An arc in GS represents an internal border gateway protocol (iBGP) session between two routers and is overlaid on some path in Gp. The set of arcs Aₛ is partitioned into three sets; over, up, and down. An arc (u, v) ∈ over represents an iBGP session from router u to v. When (u, v) ∈ over, then (v, u) ∈ over. An arc (u, v) ∈ down represents an arc from a route reflector (RR) u to one of its clients v. An arc (u, v) ∈ up represents an arc from a client u to its RR. An arc (u, v) ∈ down only when (v, u) ∈ up. Arcs in up are acyclic.

A valid signaling path S can be split into sub paths S=PQR where P=p₁p₂ . . . pₐ for some a≧0 such that each pᵢ ∈ up, R=r₁r₂ . . . r_{b} for some b>0 such that each rᵢ ∈ down and Q is either empty or consists of a single arc q ∈ over. In a particular embodiment, P, Q or R may be empty.

An egress instance I=(C, X) is a system that derives the behavior of a configuration C and a set of border routers X ⊂ B. Here, X represent border routers that learn an external BGP route to a particular network prefix that are equally good up to a certain step of the route selection process. Other routes may be eliminated by earlier steps in the BGP route selection process. X is referred to as a direct egress set. Furthermore, a downstream egress set E is defined as the union of X and the parent RRs of X (thus X is a subset of E). Although a border router may learn multiple routes of a network prefix, the border router advertises its best route only to neighbors. Therefore, there is a one-to-one mapping from border routers to available routes.

An egress instance is referred to as signaling correct when the egress instance is predicted to arrive at a particular routing. A system is referred to as being in equilibrium when the system has a single state. A system is referred to as oscillatory when the system cycles through a subset of states indefinitely in the absence of an external influence. An egress instance is referred to as signaling unstable when the egress instance has at least one oscillatory state. An egress instance is referred to as signaling stable when the egress instance has only stable states.

A router can select its best route from a set of routes A that the router learns. In a RR topology, the set A is dynamic and is determined based on decisions of other routers. However, there are many possible routes that a router may not choose in an equilibrium state. For example, a router that learns an egress directly from a neighboring AS always has this route in A, and so may not select any route that is worse. Thus, the amount of network configuration data that may be processed to identify an oscillatory behavior of a router may be reduced. A reliance graph, with each node of the reliance graph representing a router of the network, may be constructed based on the reliances or dependencies that can influence the decision of a router.

The reliance graph is calculated on a per egress instance I. The vertices of the graph are the routers, and when a first router's decision to select a route is dependent on a second router, then the first router is referred to as reliant on the second router and a directed edge is added to the reliance graph between a first node representing the first router and a second node representing the second router.

In a two-level RR hierarchy, there are three rules for constructing a reliance graph for an egress instance I=(C, X). First, a router in X, i.e. a router with a direct egress, chooses this egress and so is not reliant on any other router's decisions. Second, a client router without a direct egress is reliant on the decisions made by its parent RR(s). Third, a route reflector u is reliant on its “best” client and any other RR v whose best client router is better than u, from u's perspective, where the best client egress router for RR u ∉ X as Λ(u) ∈ X, where best is with respect to a BGP route selection process. If a RR has no client in X, then for convenience we define λv(Λ(u))=−∞ ∀ v ∈ V. Here ku represents the route selection process λ at a router u.

There are three classes of directed edges in a signaling graph and each leads to potential directed edges in the router reliance graph. For an arc (u, v), up: a client u is reliant on its RR v when u ∉ X. 2), down: a RR u is reliant on its best client egress router A(u) ∈ X, and on no other client, and over: (i) a RR u is reliant on another RR v when λu(Λ(v))>λu(Λ(u)) and (ii) a client u with an over connection to another client v is reliant on v when u ∉ X and v ∈ X.

A co-reliance group Di is a strongly connected component of the reliance graph, and we denote D(I) as the set of all co-reliance groups of an egress instance I. The co-reliance groups form a partition of the routers, i.e., each router is in exactly one co-reliance group.

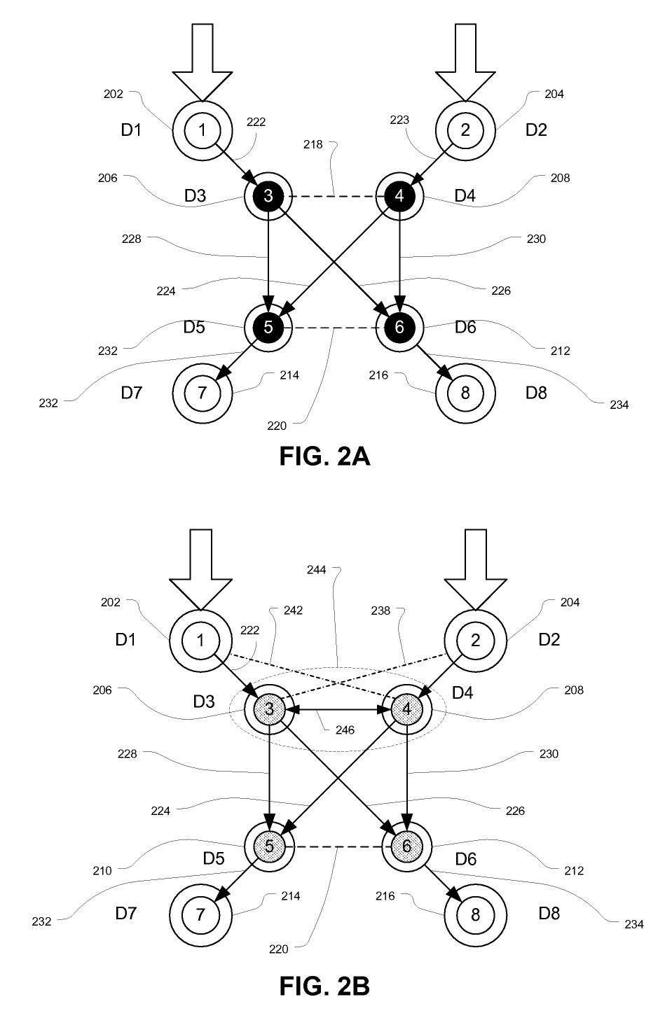

Referring to FIG. 2A, a block diagram of a first particular embodiment of a reliance graph is depicted. In FIG. 2A, D1 202, D2 204, D3 206, D4 208, D5 210, D6 212, D7 214, and D8 216 represent co-reliance groups having a single router, i.e. singleton co-reliance groups. In a network that uses iBGP, a client propagates externally learned routes to route-reflectors. A route-reflector propagates routes learned from clients to all neighboring iBGP routers and propagates routers learned from other route-reflectors to client routers.

An arrow 222 indicates that a router of the co-reliance group D3 206 may learn a route from a router of the co-reliance group D1 202. An arrow 223 indicates that a router of the co-reliance group D4 208 may learn a route from a router of the co-reliance group D2 204. An arrow 224 indicates that a router of the co-reliance group D5 210 may learn a route from a router of the co-reliance group D4 208. An arrow 228 indicates that a router of the co-reliance group D5 210 may learn a route from a router of the co-reliance group D3 206. An arrow 230 indicates that a router of the co-reliance group D6 212 may learn a route from a router of the co-reliance group D4 208. An arrow 232 indicates that a router of the co-reliance group D4 208 may learn a route from a router of the co-reliance group D2 204. An arrow 234 indicates that a router of the co-reliance group D7 214 may learn a route from a router of the co-reliance group D5 210. A line 218 between D3 206 and D4 208 and a line 220 between D5 210 and D6 212 represent iBGP sessions with no associated reliance.

When routers of the two egress co-reliance groups D1 202 and D2 204 have equally good routes then D1 202 and D2 204 ∈ X. Routers of the co-reliance groups D1 202 and D2 204 egress via the direct egress. Therefore, routers of the co-reliance groups D1 202 and D2 204 do not rely on any other router decisions. The route reflectors of the co-reliance groups D3 206 and D4 208 ∉ X, and therefore rely on the decisions of routers of the co-reliance groups D1 202 and D2 204, respectively. This reliance is illustrated by the arrow 222 between D1 202 and D3 206. Route reflectors of the co-reliance groups D5 210 and D6 212 rely only on the decisions made by routers of the co-reliance groups D3 206 and D4 208, and client routers of the co-reliance groups D7 214 and D8 216 rely on route reflectors of the co-reliance groups D5 210 and D6 212, respectively. In FIG. 2A, each router is part of its own co-reliance group and thus there is a unique solution for router decisions. Therefore, the system of FIG. 2A is predicted to be signaling correct.

Referring to FIG. 2B, a block diagram of a second particular embodiment of a co-reliance group is depicted. A line 238 from node D2 204 to node D3 206 and a line 242 from node D1 202 to node D3 206 indicates preferred clients that are not direct clients. In FIG. 2B, the route reflector node D3 206 prefers routes from the client node D2 204 and the route reflector D4 208 prefers routes from the client node D1 202, i.e. λ3(1)<X3(2) and λ4(2)<X4(1). This introduces a further reliance between nodes D3 206 and D4 208, and the nodes D3 206 and D4 208 form a single co-reliance group 244. In FIG. 2B, the equilibrium choice of routes depends on the timing of messages inside the co-reliance group 244. As multiple solutions are possible, the reliance graph of FIG. 2B is not signaling correct. However, this system does not oscillate and hence is signaling stable.

Routing oscillation occurs when a configuration instance C is not signaling stable. Oscillation occurs when routers continually modify their decision as to their route. For two routers ri and rj to alter their decision in response to each other's changes, there is a path from ri to rj and a path from rj to ri in the reliance graph. Therefore, an oscillation can only occur in a co-reliance group. Thus, predicting where oscillation occurs may be reduced to analyzing co-reliance groups. The analysis may be further reduced by eliminating singleton co-reliance groups. A singleton co-reliance group is a co-reliance group having a single router.

Non-singleton co-reliance groups can occur only in a downstream egress set E. The direct egress set X may typically have only a few routers in it. Even a large network might only peer at twenty locations, creating on the order of twenty routers in X. Each such border router might have two RRs (for redundancy), but rarely more than two RRs. Therefore, ∈ may be much smaller than the complete network. Hence, only a small portion of the network be analyzed to predict oscillation. All border routers in E are also in X and select their direct egress route, i.e. they do not rely on any other router to select a route.

In a network, the number of RRs is typically an order of magnitude smaller than the total number of routers because of the route-reflector hierarchy. In addition, the number of RRs in the downstream egress set is generally a fraction of the total number of RRs. Thus, the number of co-reliance groups that are analyzed to identify predicted oscillatory behavior can be reduced by partitioning nodes of the reliance graph into co-reliance groups and identifying a predicted oscillatory behavior of each co-reliance group.

As previously discussed, oscillation occurs within a co-reliance group and non-singleton co-reliance groups occur between the parent RRs of direct egress routers X. Therefore, every arc in the co-reliance group is an over edge, and every node in the co-reliance group knows a route learned from a client. A reliance on another RR implies that the route learned from the RR is better than the client route. Thus, when available, the route learned indirectly from another RR is selected. In a network using iBGP, when a first RR learns a route from a second RR, it does not propagate the route to a third RR.

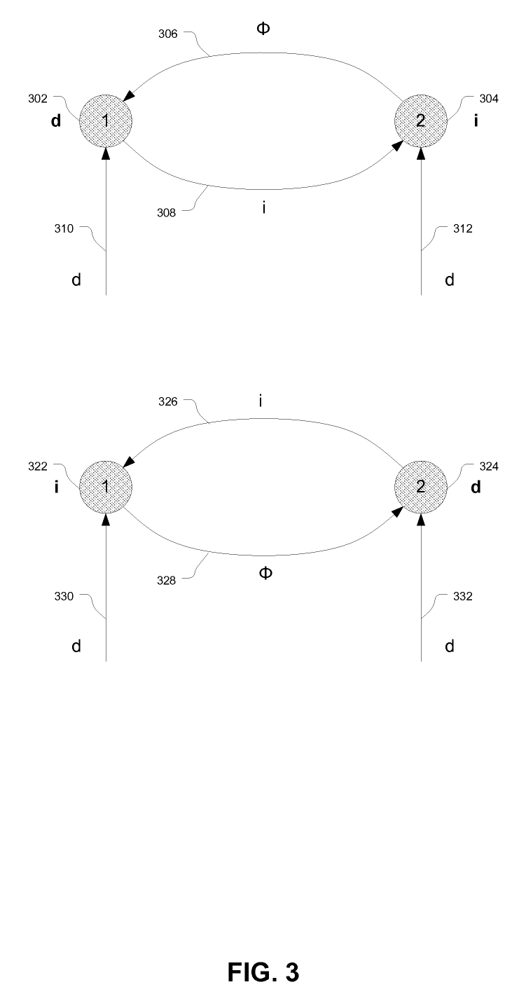

FIG. 3 is a block diagram of a third particular embodiment of a co-reliance group. FIG. 3 includes nodes 302, 304, 322, and 324, edges 306, 308, 326, and 328 and incoming arcs 310, 312, 330, and 332.

The nodes 302 and 324 have a label “d” to indicate that the nodes 302 and 324 select a direct downstream route. The nodes 304 and 322 have a label “i” to indicate that the nodes 304 and 322 select a route learned from another node. The edges 306 and 328 have a label Φ to indicate a null route, i.e. no route is selected. The preference relation i>d>Φ indicates that any route is always preferred over no route, and the indirect route is preferred over a direct route because of the construction of the co-reliance group. The nodes 302, 304, 322, and 324 make a route decision based on this preference to the labels of the incoming arcs 310, 312, 330, and 332.

The null label Φ is used for completeness to show when a router does not propagate a route. A direct route becomes indirect after propagation. A stable labeling is one in which no node has a better available route than the current chosen route. Multiple stable labelings may be possible.

For example, when the two node co-reliance group 244 of FIG. 2(B) is represented by the nodes 302 and 304, the nodes 302 and 304 have direct routes available via clients. When the nodes 302 and 304 learn of the other reflector-router routes, nodes 302 and 304 selects this indirect route. Thus, the system of FIG. 3 settles to a solution.

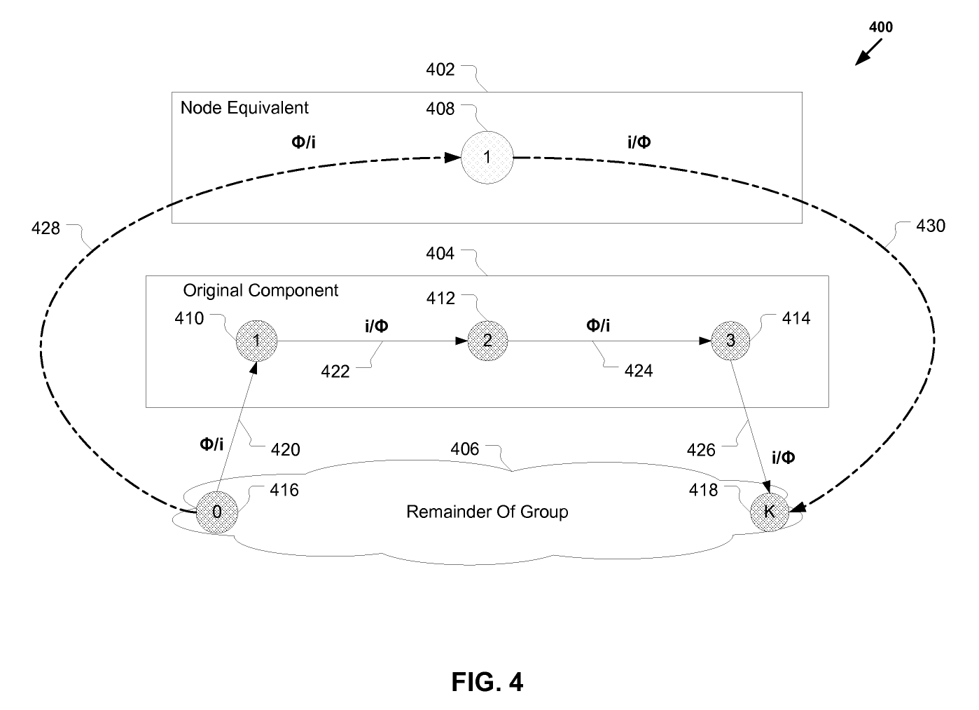

Referring now to FIG. 4, a block diagram of a fourth particular embodiment of a co-reliance group is depicted and generally designated 400. FIG. 4 illustrates how, in some cases, a larger co-reliance group may be reduced to a smaller co-reliance group that has identical predicted oscillatory properties, thereby reducing the computational resources used to analyze the co-reliance group to identify predicted oscillatory behavior.

Computationally, predicting oscillation in a co-reliance group having n number of nodes is 2ⁿ. Therefore, reducing n can reduce computation time. For example, an acyclic co-reliance group can be reduced to a single co-reliance group having a multiple input/multiple output (MIMO) function. This is because the decision of each router in the acyclical component of the co-reliance group is reliant only on the decision of the direct predecessor of each router. Therefore, the output of the acyclic component is a MIMO function of the inputs. An algorithm, such as a breadth-first traversal algorithm, may be used for computing the MIMO function for a given input. This type of algorithm is linear in the number of nodes n, so the complexity for computing the full behavior of this component is 2^{m} where there are m input edges, rather than 2ⁿ.

FIG. 4 includes a node equivalent 402, an original component 404, and a remainder of the group 406. FIG. 4 illustrates how an odd-node path, such as the original component 404, may be reduced to a single node path, such as the node equivalent 402. The node equivalent 402 has a single node 408. The original component 404 has nodes 410, 412, and 414 and reliances 422 and 424. The remainder of group 406 includes nodes 416 and 418. The node 416 has a reliance 420 with node 410 and node 418 has a reliance 426 with node 414.

The original component 404 is acyclical and consists of a single input/single output configuration having the three nodes 410, 412, and 414. The node equivalent 402 has the single node 408 and is equivalent to the predicted behavior of the original component 404 that has the three nodes 410, 412, and 414.

Thus, as the stability of each co-reliance group of the reliance graph is analyzed and predicted, the structure of each co-reliance group may be added to a library of knowledge, such as the library 130 in FIG. 1. The library may store co-reliance groups in the form of the reduced node equivalent group. The library may be used in conjunction with the techniques described herein to reduce a new co-reliance group to one already in the library. By reducing co-reliance groups to a reduced node equivalent group, the number of nodes that are analyzed to identify a predicted oscillatory behavior may be reduced, thereby reducing the computational requirements of the analysis.

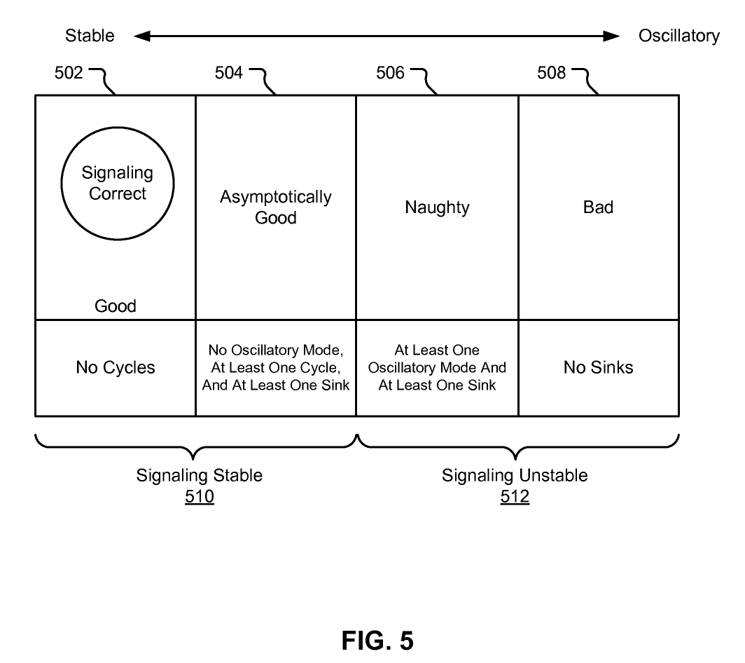

Referring now to FIG. 5, an illustrative embodiment of a table of predicted oscillatory behavior is depicted. A co-reliance group is predicted as having an oscillatory behavior of good 502 when the co-reliance group is predicted to have no cycles and to be signaling correct. A co-reliance group is predicted as having an oscillatory behavior of asymptotically good 504 when the co-reliance group is predicted to have no oscillatory mode, at least one cycle, and at least one sink. The oscillatory behavior of asymptotically good 504 means that after a finite period of time the group has the oscillatory behavior of good 502. A co-reliance group predicted to have the good 502 or the asymptotically good oscillatory behaviors is referred to as signaling stable 510 because it will not oscillate at some point in time.

A co-reliance group is predicted as having an oscillatory behavior of naughty 506 when the co-reliance group is predicted to have at least one oscillatory mode and at least one sink. A co-reliance group is predicted as a having an oscillatory behavior of bad 508 when the co-reliance group is predicted to have no sinks. A co-reliance group predicted to have the naughty 506 or the bad 508 oscillatory behaviors is referred to as signaling unstable 512 because the co-reliance group has route oscillation.

When a co-reliance group or its equivalent is not found in the library, a state-machine may be used to predict the oscillatory properties of the co-reliance group. Each state is a labeling of nodes in the reliance graph. For example, the labeling idi represents one possible labeling of three nodes (Node 0: i, Node 1: d, Node 2: i). Each transition of the state machine represents a node changing its selection of a route to another available route different than the currently selected route. Nodes and edges refer to a co-reliance group while states and transitions refer to a state-machine representation of the co-reliance group.

A state machine has a stable state when all nodes have selected their best available route and is depicted as a sink in the state-machine graph. A state machine has a predicted oscillatory behavior when the state-machine graph has a subset of communicating states with no sink and no transitions out of the subset because in such a mode, the state machine oscillates persistently.

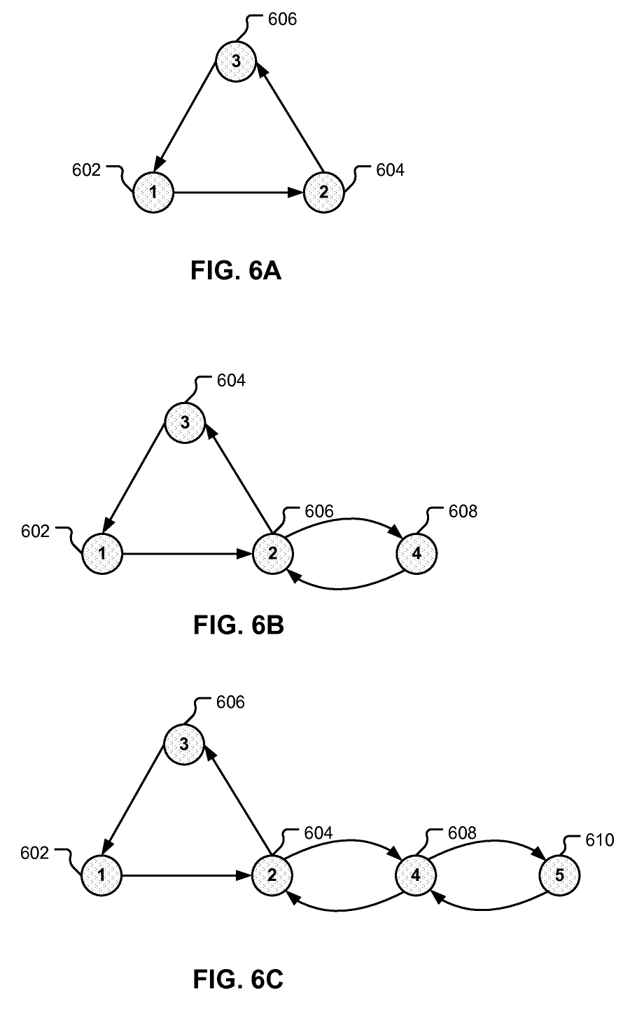

FIG. 6A is a block diagram of a first particular embodiment of a reliance graph. FIG. 6A includes a first node 602, a second node 604, and a third node 606. FIG. 6A illustrates a reliance graph having the bad 508 predicted oscillatory behavior of FIG. 5.

FIG. 6B is a block diagram of a second particular embodiment of a reliance graph. FIG. 6B includes the first node 602, the second node 604, the third state node, and a fourth node 608. FIG. 6B illustrates a reliance graph having the asymptotically good 504 predicted oscillatory behavior of FIG. 5..

FIG. 6C is a block diagram of a third particular embodiment of a reliance graph. FIG. 6C includes the first node 602, the second node 604, the third node 606, the fourth node 608, and a fifth node 610. FIG. 6C illustrates a reliance graph having the naughty 506 predicted oscillatory behavior of FIG. 5.

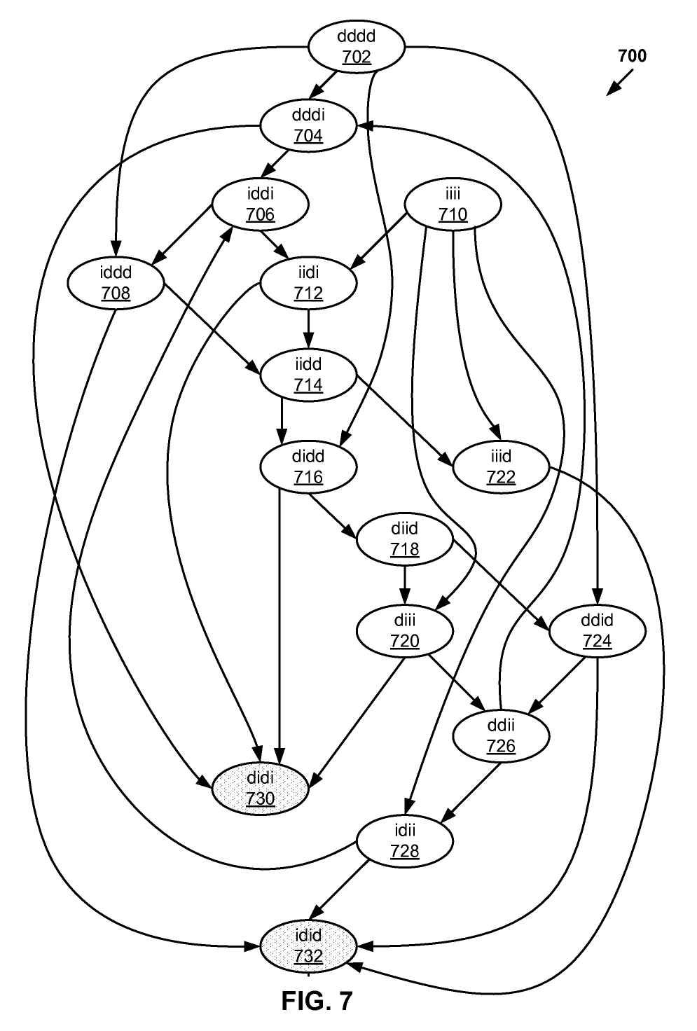

FIG. 7 is a block diagram of a first particular embodiment of a state machine 700. The state machine 700 illustrates a state-machine having the good 502 predicted oscillatory behavior of FIG. 5. The state machine 700 represents a four node co-reliance graph having sixteen states. The state machine 700 has the transient states states dddd 702, dddi 704, iddi 706, iddd 608, iiii 710, iidi 712, iidd 714, didd 716, diid 718, diii 720, iiid 722, ddid 724, ddii 726, and idii 728. The state-machine 700 is acyclic and has two stable sink states, state didi 730 and state idid 732. The state machine 700 has the good 502 predicted oscillatory behavior of FIG. 5 because of the two stable sink states 730 and 732. Thus, a portion of the network configuration data 118 of FIG. 1 associated with the routers corresponding to the state machine 700 are not modified by the network analysis device 110.

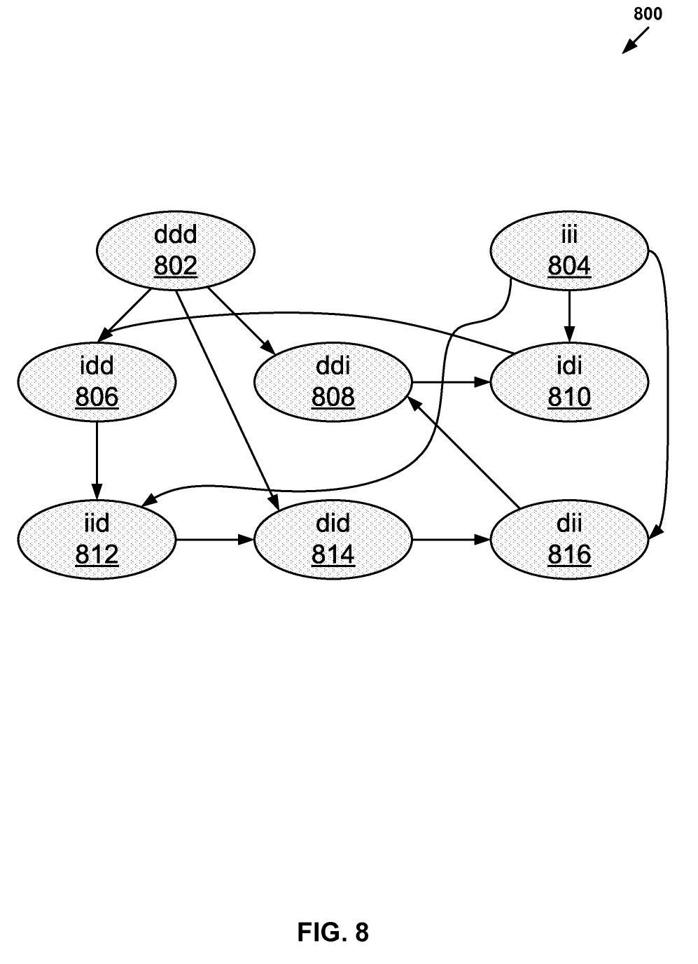

FIG. 8 is a block diagram of a second particular embodiment of a state machine 800. The state machine 800 illustrates a state-machine representing a three-node co-reliance group having eight states and the bad 508 predicted oscillatory behavior.

The state machine 800 has states ddd 802, iii 804, idd 806, ddi 808, idi 810, iid 812, did 814, and dii 816. The state machine 800 has no sink states because each of the states 802, 804, 806, 808, 810, 812, 814, and 816 has an outbound transition. Therefore, none ofthe states 802, 804, 806, 808, 810, 812, 814, and 816 are stable. Hence, the state machine 800 is predicted to have the bad 508 oscillatory behavior of FIG. 5 with a cycle consisting of (idi, idd, iid, did, dii, ddi). Thus, a portion of the network configuration data 118 of FIG. 1 associated with the routers corresponding to the state machine 800 are modified by the network analysis device 110 to remove route oscillation.

Co-reliance groups can be reliant on other co-reliance groups containing RRs. When a first co-reliance group is reliant on a second co-reliance group the second co-reliance is not reliant on the first co-reliance group because of the hierarchical nature of reliances. Hence, any inbound edge to a co-reliance group is fixed.

An inbound edge from another RR can be labeled (p or i. When an inbound edge is labeled φ, no additional information is available in the co-reliance group and thus is equivalent to the group being considered in isolation. However, when it is labeled i, the reliant node in the co-reliance group is fixed to be i. Thus, a number of states in the state machine are inaccessible.

When an inbound edge to a co-reliance group is labeled i, then its state machine is a sub-graph of its state machine when considered in isolation. When an inbound reliance edge is connected to node uⱼ and is labeled i, node uⱼ is fixed to select i (as no route can be better than i). Consequently, only states in the isolated co-reliance group state machine with uⱼ labeled i are feasible. Also, no new transitions between states are possible. Hence, the state machine of the co-reliance group is a subgraph of the isolated co-reliance group state machine.

When a co-reliance group has a good predicted oscillatory behavior in isolation, then the co-reliance group has a good predicted oscillatory behavior with any inbound edges. Given an egress instance, the oscillatory properties of the egress instance may be determined. When the egress instance contains all singleton co-reliance groups, or all non-singleton co-reliance groups are signaling stable, the egress instance is signaling stable. When all feasible egress instances in a configuration are signaling stable, then the configuration is signaling stable.

All of the reliances we have currently considered are strong reliances, in which when a RR learns a route from one of the RR's reliances, the RR selects that route. Strong reliances may exist when the IGP distance is used as a tie-breaker. However, when the IGP distance is equal for multiple routes and the oldest-route is the tie-breaker, then the reliance is weak because when a route is learned from another node the weak reliance implies that the node may select the route learned from this node. However, when a reliance is weak, and a node selects the direct route of the node, the node may not change the selected route as the selected route is available and is the oldest route.

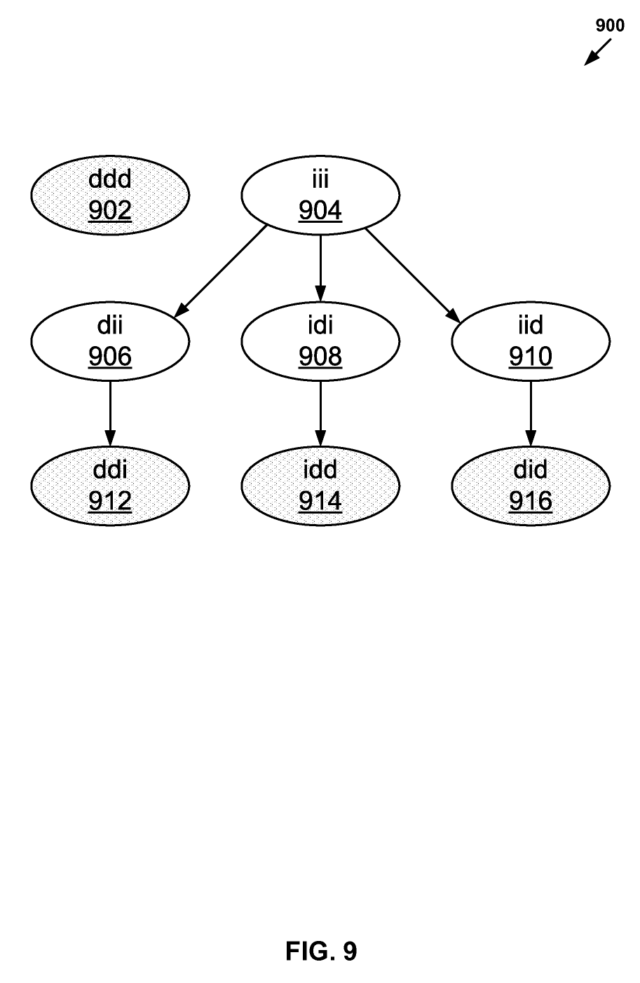

Referring to FIG. 9, a block diagram of a third particular embodiment of a state machine is depicted and generally designated 900. The state machine 900 includes the transient states iii 904, dii 906, idi 908, and iid 910 and the sink states ddd 902, ddi 912, idd 914, and did 916. The state machine 900 illustrates how the state-machine 800 of FIG. 8 having the three node oscillatory configuration may be modified using a new tie-break rule of choosing an oldest route so that all reliances are weak. The state-machine 900 is simpler than the state-machine of FIG. 8 because many of the state transitions have been removed since they do not occur under the new tie-break rule. Thus, the state machine 900 has four stable sink states, ddd 902, ddi 912, idd 914, and did 916 and has the good 502 predicted oscillatory behavior of FIG. 5.

By using a tie-breaker rule of selecting the oldest route among the routes that are tied, the three node state machine 900 has the good 502 predicted oscillatory behavior of FIG. 5. In contrast, the three node state machine 800 of FIG. 8 has the bad 508 predicted oscillatory behavior because the state machine 800 does not use the tie-breaker rule of selecting the oldest route. In FIG. 1, the modified network design file 112 may include modifying a tie-breaker rule of at least one of the routers 105-107 to have the tie-breaker rule of selecting the oldest route.

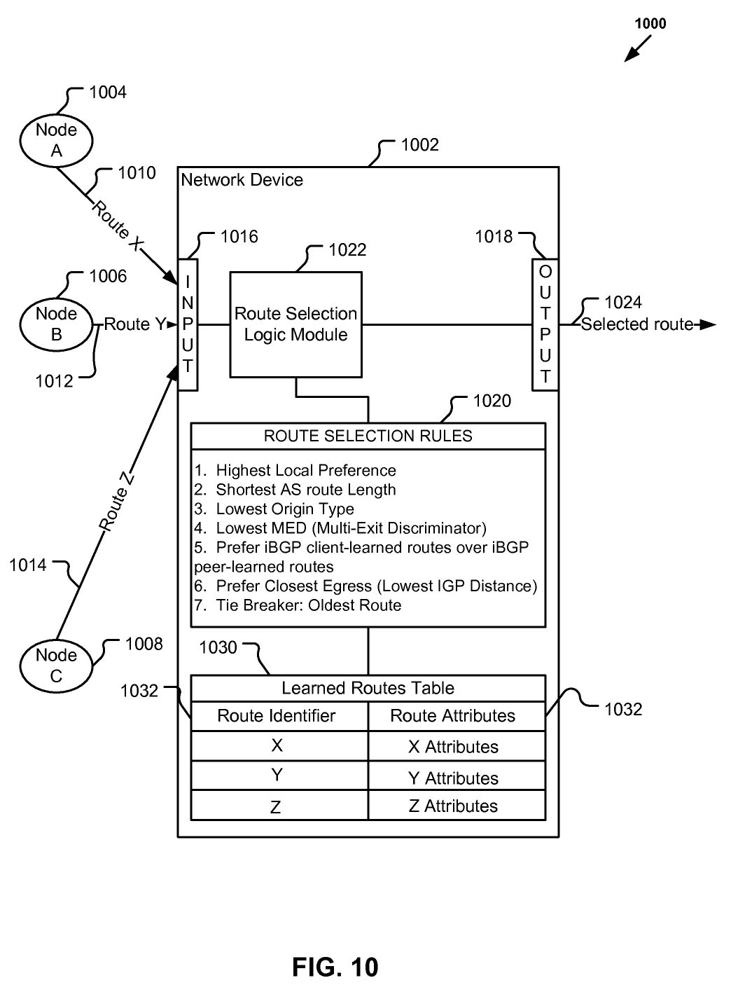

Referring to FIG. 10, a block diagram of a system having a route selection process to prevent oscillatory behavior is depicted and generally designated as 1000. The system 1000 includes a network device 1002, a node A 1004, a node B 1006, and node C 1008.

The network device 1002 includes an input 1016, an output 1018, route selection rules 1020, a route selection logic module 1022, and a learned routes table 1030. Each route in the learned routes table 1030 has a route identifier 1032 and route attributes 1032. In a particular embodiment, the route attributes 1032 included information associated with how long the route has been stored at the learned routes table 1030. For example, the route attributes 1032 may be used to determine which route among the routes of the learned routes table 1030 is the oldest route. The network device 1002 is configured to receive the routes X 1010, Y 1012, and Z 1014 from other nodes and store the received routes at the learned routes table 1030. The network device 1002 is further configured to select a route from the learned routes table 1030 based on the route selection rules 1020 and output the selected route 1024.

The route selection rules 1020 specify that the selected route 1024 is selected by considering a route having the highest local preference, a shortest AS path length, a lowest origin type, a lowest multi-exit discriminator (MED), preferring client-learned routes over peer-learned routes, a closest egress (i.e. lowest IGP distance), and when there is a tie among the routes with respect to the previous factors, selecting an oldest route.

In operation, the network device 1002 receives a route X 1010 from the node A 1004, a route Y 1012 from the node B 1006 and a route Z 1014 from the node C 1008. The route selection logic module 1022 uses the route selection rules 1020 to determine which of the received routes X 1010, Y 1012, and Z 1014 to use when routing received packets (not shown) and then selects the route as the selected route 1024.

The tie break rule of selecting the oldest route enables strong reliances where there is a tie in the IGP distances. An extended algebra may be used to describe the routes as strong (is) and weak (iw) indirect routes, where Σ={d, is, iw, φ} with the preference relation is>iw˜=d>Φ, where under the ˜=operator, the oldest route is chosen. The arcs in the reliance graph are now labeled weak or strong and the mapping function ⊕ now depends on this labeling as shown in Table 1.

TABLE 1

| Node Label | Weak Reliance | Strong Reliance |
|---|---|---|
| d | i_{w} | iₛ |
| i_{w} | φ | φ |
| iₛ | φ | φ |
| φ | φ | φ |

A single cycle consisting of at least one weak reliance may be shown as not oscillating. It follows that a cycle of strong reliances is required for a co-reliance group to oscillate. Consequently, all weak reliances in a co-reliance group do not need to be analyzed when identifying predicted oscillatory behavior. Thus, if a co-reliance group contains no strong cycles, it is signaling stable. Hence, in general the oldest-path tie-breaker, although possibly less deterministic as there are more stable states, is less likely to be oscillatory than the lowest-router-id tie-breaker.

When predicting an oscillatory behavior of an AS, the entire reliance graph for an egress instance does not to be calculated. Instead, the reliance graph of the downstream egress set may be used. The amount of nodes to be analyzed may be reduced by analyzing only individual co-reliance groups that are often smaller than the egress set because RRs are typically close to their clients with respect to IGP distances. The number of nodes to be analyzed may be further reduced by replacing common acyclic components with a reduced component. The state-machine of the reduced co-reliance group may be analyzed to detect sinks, and predict oscillatory behavior.

A large network has many potential egress instances, |I|=2^{B}−1, where B is the number of border routers. However, all of the potential egress instances do not need to be analyzed because import policies on border routers may prevent a number of egresses ever being used in combination.

By using the route selection rules 1020 that include preferring iBGP client-learned routes over iBGP peer-learned routes in step five and choosing an oldest route as a tie-breaker, oscillatory behavior may be reduced or, in some cases, eliminated. The route selection rules 1020 enable a network operator to design a network with minimal network oscillation while providing the network operator design flexibility. Flexibility is achieved because the route selection rules used by each router are designed to minimize or eliminate oscillatory behavior.

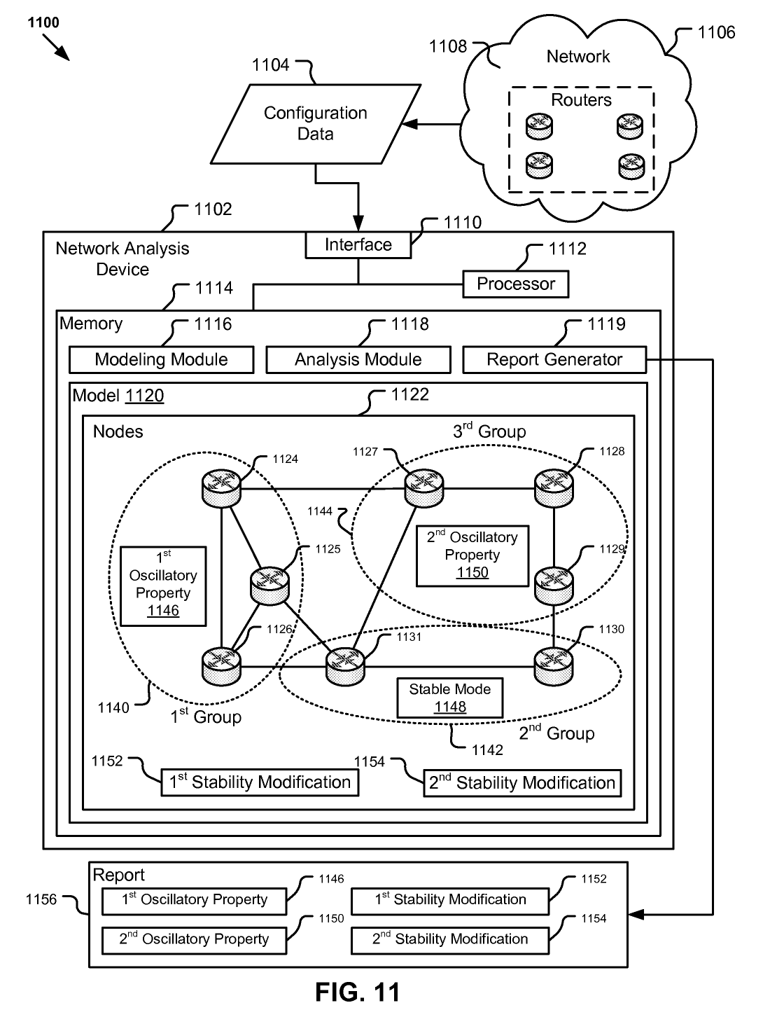

Referring to FIG. 11, a block diagram of a third particular embodiment of a system to identify a predicted oscillatory behavior is depicted and generally designated 1100. The system 1100 includes a network analysis device 1102, configuration data 1104, and a network 1106.

The network 1106 includes a plurality of routers 1108. The configuration data 1104 is associated with the network 1106.

The network analysis device 1102 includes an interface 1110, a processor 1112, and a memory 1114. The memory 1114 includes a modeling module 1116, an analysis module 1118, a report generator 1119, and a model 1120. The model 1120 is a network representation modeling a behavior of the network 1106 based on the configuration data 1104. The model 1120 includes nodes 1122. The nodes 1122 include a first group of nodes 1140, a second group of nodes 1142, a third group of nodes 1144, a first stability modification 1152, and a second stability modification 1154. In a particular embodiment, the first group of nodes 1140, the second group of nodes 1142, and the third group of nodes 1144 are each co-reliance groups. The first group of nodes 1140 includes nodes 1124, 1125 and 1126, and a first oscillatory property 1146. The second group of nodes 1142 includes nodes 1130 and 1131 and a stable mode 1148. The third group of nodes 1144 includes nodes 1127, 1128 and 1129 and a second oscillatory property 1150. The interface 1110 is operable to receive the configuration data 1104 representing the routers 1108 of the network 1106. The modeling module 1116 is operable to create the model 1120 representing the network 1106 based on the configuration data 1104. The model 1120 includes the nodes 1124-1131 corresponding to the routers 1108 of the network 1106. The analysis module 1118 is operable to group each of the nodes 1124-1131 based on at least one characteristic of the associated router and to identify an oscillatory property of each group of nodes of the model. The report generator 1119 is operable to generate a report 1156 identifying the first oscillatory property 1146, and the second oscillatory property 1150 of each of the groups 1144 and 1146.

In operation, the configuration data 1104 is created based on the routers 1108 of the network 1106 and the configuration data 1104 is received at the interface 1110. The modeling module 1116 receives the configuration data 1104 from the interface 1110 and creates the model 1120 of the network 1106. The analysis module 1118 analyzes the nodes 1122 of the model 1120 to determine the first oscillatory property 1146, the second oscillatory property 1150, and the stable mode 1148 of the nodes 1122. The analysis module 1118 is further operable to remove groups having the stable mode 1148 from the model 1120. Groups of nodes having the stable mode 1148 are removed from the model 1120 so that fewer nodes need to be analyzed to determine the oscillatory properties of the nodes. The analysis module 1118 identifies the first stability modification 1152 and the second stability modification 1154. The group of nodes has the stable mode 1148 when the model includes the first stability modification 1152 or the second stability modification 1154. The report generator 1119 generates the report 1156 identifying the first oscillatory property 1146, the second oscillatory property 1150, the first stability modification 1152, and the second stability modification 1154.

By generating the report 1156, the network 1106 may be modified using the first stability modification 1152 and the second stability modification 1154 in order to eliminate the first oscillatory property 1146 and the second oscillatory property 1150. In this way, oscillatory properties of the network 1106 may be identified in the report 1156 and stability modifications may be suggested to remove the oscillatory properties.

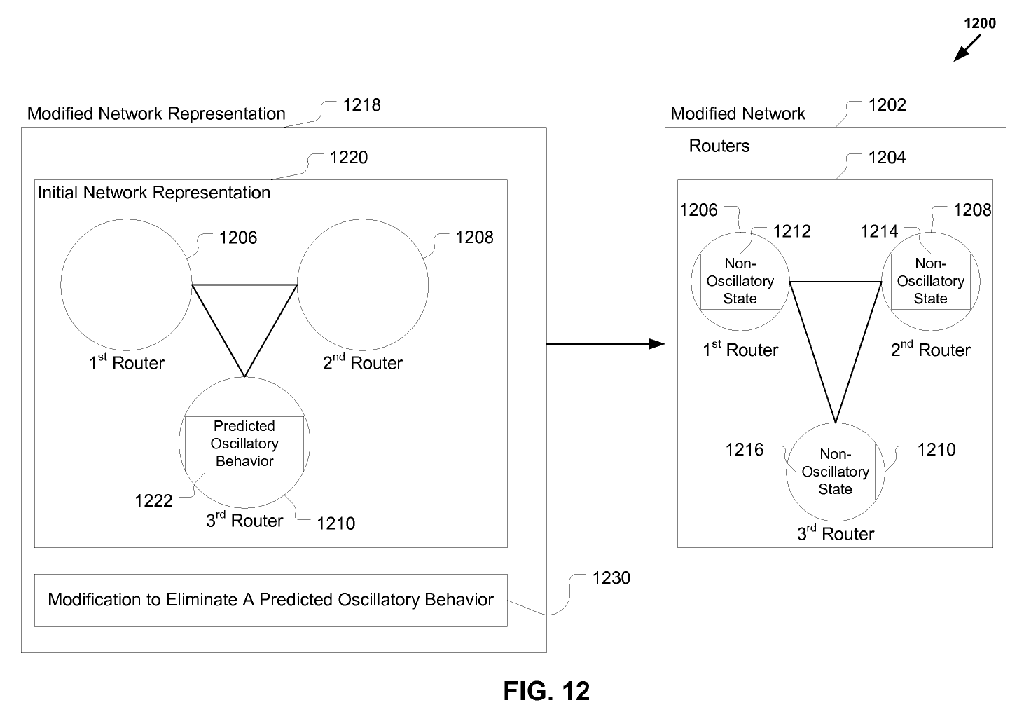

Referring to FIG. 12, a block diagram of a fourth particular embodiment of a system to identify a predicted oscillatory behavior is depicted and generally designated 1200. The system 1200 includes a modified network 1202 and a modified network representation 1218.

The modified network 1202 includes routers 1204. The routers 1204 include a first router 1206 having a non-oscillatory state 1212, a second router 1208 having a non-oscillatory state 1214, and a third router 1210 having a non-oscillatory state 1216. The modified network 1202 has an associated modified network representation 1218.

The modified network representation 1218 includes an initial network representation 1220 and a modification to eliminate the predicted oscillatory behavior 1230. The initial network representation 1220 includes the first router 1206, the second router 1208, and the third router 1210 having a predicted oscillatory behavior 1222.

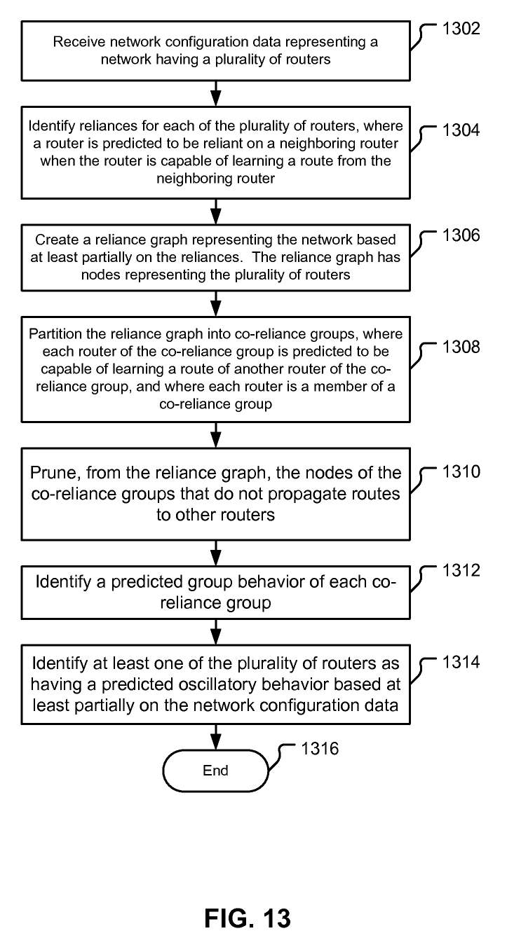

Referring to FIG. 13, a flow diagram of a first particular embodiment of a method to identify a predicted oscillatory behavior is depicted. The method may be performed by the software instructions 128 in FIG. 1, the route selection logic module 1022 in FIG. 10, or the analysis module 1118 in FIG. 11.

Network configuration data representing a network having a plurality of routers is received, at 1302. Moving to 1304, reliance of each of the plurality of routers are identified. A router is predicted to be reliant on a neighboring router when the router is capable of learning a route from the neighboring router. Advancing to 1306, a reliance graph representing the network is created based at least partially on the reliances. The reliance graph has nodes representing the plurality of routers. Proceeding to 1308, the reliance graph is partitioned into co-reliance groups. Each router of the co-reliance group is predicted to be capable of learning a route of another router of the co-reliance group. Each router is a member of a co-reliance group. Advancing to 1310, the nodes of the co-reliance group that do not propagate routes to other routers are pruned from the reliance graph. Moving to 1312, a predicted group behavior of each co-reliance group is identified. Continuing to 1314, at least one of the plurality of routers is identified as having a predicted oscillatory behavior based at least partially on the network configuration data. The method ends at 1316.

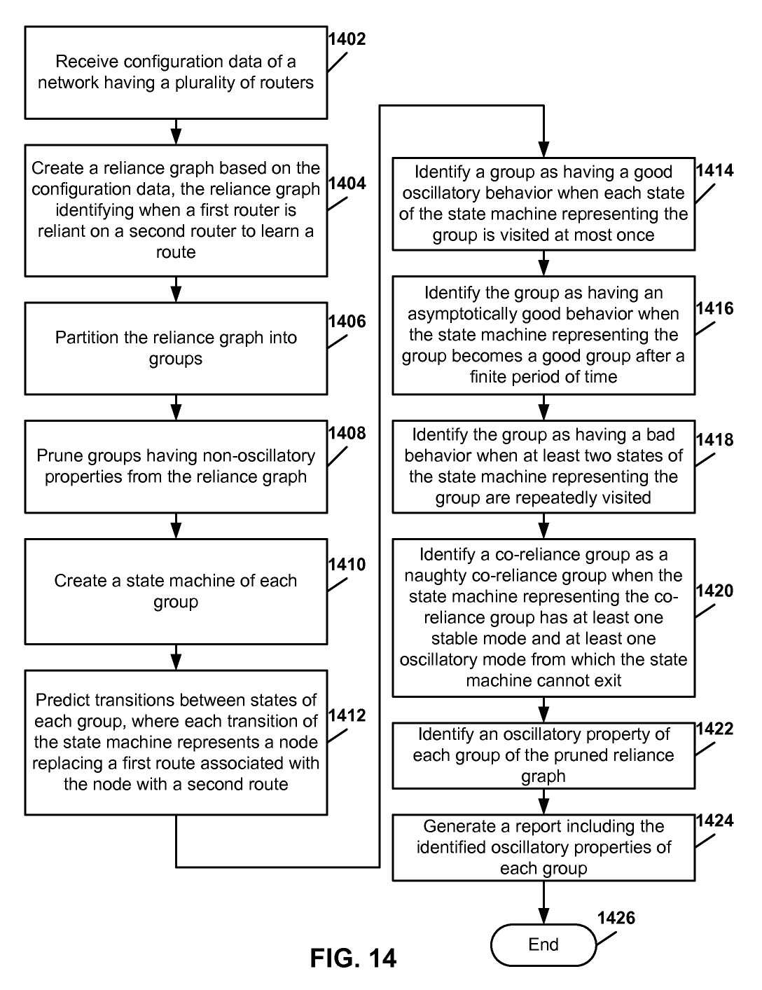

Referring to FIG. 14, a flow diagram of a second particular embodiment of a method to identify a predicted oscillatory behavior is depicted. The method may be performed by the network analysis device 110 of FIG. 1 or the network analysis device 1102 of FIG. 11.

Configuration data of a network having a plurality of routers is received, at 1402. Moving to 1404, a reliance graph is created based on the configuration data. The reliance graph identifies when a first router is reliant on a second router to learn a route. Moving to 1406, the reliance graph is partitioned into groups. For example, the reliance graph may be partitioned into co-reliance groups. Advancing to 1408, the groups having non-oscillatory properties are pruned from the reliance graph. For example, singleton co-reliance groups may be pruned from the reliance graph. Proceeding to 1410, a state machine of each group may be created. Advancing to 1412, transitions between states of each group may be predicted. Each transition of the state machine represents a node replacing a first route associated with a node with a second route. Moving to 1414, a group may be identified as having a good oscillatory behavior when each state of the state machine representing the group is visited at most once. Moving to 1416, the group may be identified as having an asymptotically good behavior when the state machine has one or more cycles, one or more sinks and from every cycle there is a way out to one of the sinks. Proceeding to 1418, the group may be identified as having a bad behavior when at least two of the states of the state machine representing the group are repeatedly visited. Continuing to 1420, a co-reliance group may be identified as a naughty co-reliance group when the state machine representing the co-reliance group has at least one stable mode and at least one at least oscillatory mode from which the state machine cannot exit. Proceeding to 1422, an oscillatory property of each group of the pruned reliance group is identified. Advancing to 1424, a report is generated including the identified oscillatory properties of each group. The method ends at 1426.

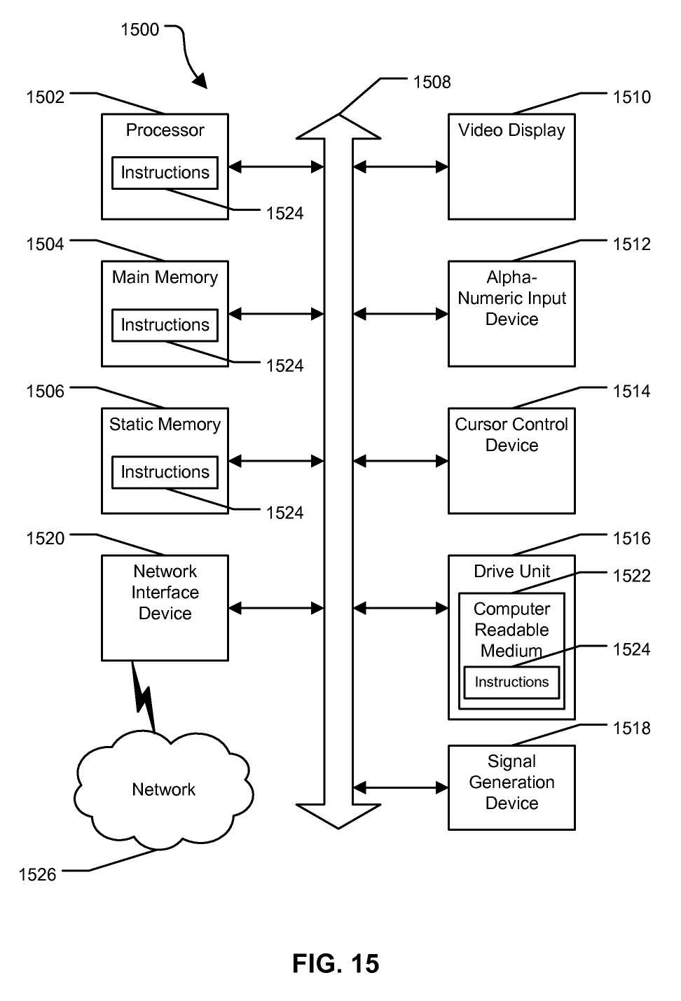

Referring to FIG. 15, an illustrative embodiment of a general computer system is shown and is designated 1500. The computer system 1500 can include a set of instructions that can be executed to cause the computer system 1500 to perform any one or more of the methods or computer based functions disclosed herein. The computer system 1500, or any portion thereof, may operate as a standalone device or may be connected, e.g., using a network, to other computer systems or peripheral devices.

In a networked deployment, the computer system may operate in the capacity of a router, such as the routers 105-107 of FIG. 1. The computer system 1500 can also be implemented as or incorporated into various devices, such as a personal computer (PC), a tablet PC, a router, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1500 can be implemented using electronic devices that provide voice, video or data communication. Further, while a single computer system 1500 is illustrated, the term “system” shall also be taken to include any collection of systems or sub-systems that individually or jointly execute a set, or multiple sets, of instructions to perform one or more computer functions.

As illustrated in FIG. 15, the computer system 1500 may include a processor 1502, e.g., a central processing unit (CPU), a graphics-processing unit (GPU), or both. Moreover, the computer system 1500 can include a main memory 1504 and a static memory 1506 that can communicate with each other via a bus 1508. As shown, the computer system 1500 may further include a video display unit 1510, such as a liquid crystal display (LCD), an organic light emitting diode (OLED), a flat panel display, a solid-state display, or a cathode ray tube (CRT). Additionally, the computer system 1500 may include an input device 1512, such as a keyboard, and a cursor control device 1514, such as a mouse. The computer system 1500 can also include a disk drive unit 1516, a signal generation device 1518, such as a speaker or remote control, and a network interface device 1520.

In a particular embodiment, as depicted in FIG. 15, the disk drive unit 1516 may include a computer-readable medium 1522 in which one or more sets of instructions 1524, e.g. software, can be embedded. Further, the instructions 1524 may embody one or more of the methods or logic as described herein. In a particular embodiment, the instructions 1524 may reside completely, or at least partially, within the main memory 1504, the static memory 1506, and/or within the processor 1502 during execution by the computer system 1500. The main memory 1504 and the processor 1502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1524 or receives and executes instructions 1524 responsive to a propagated signal, so that a device connected to a network 1526 can communicate voice, video or data over the network 1526. Further, the instructions 1524 may be transmitted or received over the network 1526 via the network interface device 1520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal including computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer-readable storage medium comprising operational instructions, that when executed by a processor, cause the processor to:
receive network configuration data representing a network having a plurality of routers; and
identify at least one of the plurality of routers as having a predicted oscillatory behavior based at least partially on the network configuration data.

2. The computer-readable storage medium of claim 1, wherein each router has a route associated with the router and wherein a router has the predicted oscillatory behavior when the router is predicted to repeatedly select a route previously discarded by the router.

3. The computer-readable storage medium of claim 1, further comprising operational instructions, that when executed by the processor, cause the processor to:
identify reliances for each of the plurality of routers, wherein a router is predicted to be reliant on a neighboring router when the router is capable of learning a route from the neighboring router;
create a reliance graph representing the network based at least partially on the reliances, the reliance graph having nodes representing the plurality of routers; and
prune, from the co-reliance graph, the nodes of the co-reliance graph that do not propagate routes to other routers.

4. The computer-readable storage medium of claim 3, further comprising operational instructions, that when executed by the processor, cause the processor to:
partition the reliance graph into co-reliance groups, wherein each router of the co-reliance group is predicted to be capable of learning the route of another router of the co-reliance group, and wherein each router is a member of a co-reliance group;
identify a predicted group behavior of each co-reliance group.

5. The computer-readable storage medium of claim 4, further comprising operational instructions, that when executed by the processor, cause the processor to create state machines corresponding to the co-reliance groups and to predict transitions between states of each state machine, wherein each transition of each state machine represents a node of the co-reliance group predicted to replace a first route of the node with a second route learned from another node of the co-reliance group.

6. The computer-readable storage medium of claim 5, further comprising operational instructions, that when executed by the processor, cause the processor to identify a co-reliance group as having a predicted good group behavior when each state of the state machine representing the co-reliance group is visited at most once.

7. The computer-readable storage medium of claim 6, further comprising operational instructions, that when executed by the processor, cause the processor to identify the co-reliance group as having a predicted asymptotically good group behavior when the state machine representing the co-reliance group determines that the co-reliance group exhibits the predicted good group behavior after a finite period of time.

8. The computer-readable storage medium of claim 5, further comprising operational instructions, that when executed by the processor, cause the processor to identify a co-reliance group as having a predicted bad group behavior when each state of the state machine is repeatedly visited.

9. The computer-readable storage medium of claim 5, further comprising operational instructions, that when executed by the processor, cause the processor to identify a co-reliance group as having a predicted naughty group behavior when the state machine representing the co-reliance group has at least one stable mode and at least one oscillatory mode from which the state machine cannot exit.

10. The computer-readable storage medium of claim 1, further comprising operational instructions, that when executed by the processor, cause the processor to modify the network configuration data to prevent the predicted oscillatory behavior, and to output a report including the modified network configuration data.

11. The computer-readable storage medium of claim 10, wherein each router of the modified network configuration data is predicted to have a non-oscillatory behavior.

12. The computer-readable storage medium of claim 1, wherein the plurality of routers are configured to use at least one of an internal border gateway protocol (iBGP) and an interior gateway protocol (IGP).

13. A method, comprising:
receiving configuration data of a network having a plurality of routers;
creating a reliance graph based on the configuration data, the reliance graph identifying when a first router is reliant on a second router to learn a route;
partitioning the reliance graph into groups;
pruning groups having non-oscillatory properties from the reliance graph;
identifying an oscillatory property of each group of the pruned reliance graph; and
generating a report including the identified oscillatory properties of each group.

14. The method of claim 13, wherein identifying the oscillatory property of each group comprises:
creating a state machine of each group; and
predicting transitions between states of each group, wherein each transition of the state machine represents a node replacing a first route associated with the node with a second route.

15. The method of claim 14, wherein the node replaces the first route with the second route when the node receives the second route from another node of the group and determines that the second route is a better route than the first route.

16. The method of claim 14, further comprising identifying a group as having a good oscillatory behavior when each state of the state machine representing the group is visited at most once.

17. The method of claim 15, further comprising identifying the group as having an asymptotically good behavior when the state machine representing the group becomes a good group after a finite period of time.

18. The method of claim 14, further comprising identifying the group as having a bad behavior when at least two states of the state machine representing the group are repeatedly visited.

19. The method of claim 14, further comprising identifying a co-reliance group as a naughty co-reliance group when the state machine representing the co-reliance group has at least one stable mode and at least one oscillatory mode from which the state machine cannot exit.

20. A system, comprising:
an interface operable to receive data representing routers of a network;
a modeling module operable to create a model representing the network based on the data, the model including a plurality of nodes corresponding to the routers of the network;
an analysis module operable to group each of the nodes based on at least one characteristic of the associated router and to identify an oscillatory property of each group of nodes of the model; and
a report generator operable to generate a report identifying the oscillatory property of each group of nodes of the model.

21. The system of claim 20, wherein the analysis module is further operable to remove groups having a stable mode from the model.

22. The system of claim 20, wherein the analysis module is further operable to identify a stability modification associated with each group of nodes having the oscillatory property.

23. The system of claim 20, wherein each group of nodes has a stable mode when the model includes the stability modification.

24. The system of claim 20, wherein the report identifies the stability modification.

25. An autonomous system, comprising:
a modified network comprising a plurality of routers, each router having a non-oscillatory state, the modified network associated with a modified network representation; and
wherein the modified network representation includes an initial network representation including at least one router having a predicted oscillatory behavior and a modification to eliminate the predicted oscillatory behavior.
